(19) United States
(12) Patent Application Publication
(10) Pub. No.: US 2022/0295844 A1
(43) Pub. Date: Sep. 22, 2022

(54) Method Of Processing Sugar Beet And Its Varieties Into A Product Usable In The Food-Processing Industry, The Product Obtained In This Way And Food Containing This Product

(71) Applicant: Boris Zitný, Nitra (SK)

(72) Inventor: Boris Zitný, Nitra (SK)

(21) Appl. No.: 17/753,334

(22) PCT Filed: Sep. 2, 2020
(86) PCT No.: PCT/SK2020/050014

§ 371 Date: Feb. 28, 2022

(30) Foreign Application Priority Data
Sep. 3, 2019 (SK) PCT/SK2019/050010
Mar. 4, 2020 (SK) PP 50011-2020

(51) Int. Cl. A23L 19/10; A23L 19/00; A23B 7/154; A23B 7/015; A23B 7/148; A23L 33/105; A23L 33/115; A23L 33/125; A23L 33/16; A23L 33/21; A23L 5/20

(52) U.S. Cl. CPC A23L 19/10; A23L 19/09; A23B 7/154; A23B 7/015; A23B 7/148; A23L 33/105; A23L 33/115; A23L 33/125; A23L 33/16; A23L 33/21; A23L 5/20

(57) ABSTRACT

A method of processing sugar beet and its varieties. It includes inactivation of the material against degradation by mixing sugar beet material with one or more alcohols selected from the group of alcohols containing one to four carbon atoms in the molecule and one hydroxyl group in such a ratio that the minimum alcohol concentration in the resulting liquid phase of the mixture is at least 60% by volume at a temperature from −15° C. to 180° C. The mixture of sugar beet and alcohol is maintained for 0 minutes to 600 minutes. The sugar beet roots before, during or after the inactivation step are disintegrated to a material of particles where at least one of the particle dimensions is less than or equal to 50 mm. The liquid phase is removed from the mixture to form a product with a dry-matter content of 40% by weight up to 99% by weight.

### TECHNICAL FIELD

The present teaching relates to the method for processing sugar beet into products applicable in the food industry and in human nutrition.

### BACKGROUND

Sugar beet (Beta Vulgaris) is an industrial crop grown in large quantities for the sugar industry for the purpose of producing beet sugar. The method of processing sugar beet in industrial sugar refineries is well-known and the process is well-described in literature.

Excessive consumption of sugars leads to health problems and diseases of civilisation. The use of whole sugar beet root not only as a source of sugar, but also as a source of nutrients and fibre is a very beneficial nutritional and economic solution. The root of sugar beet contains high contents of many essential minerals, especially potassium, sodium, magnesium, calcium, iron, fluorine, zinc, copper and manganese (chemical elements in their respective order: K, Na, Mg, Ca, Fe, F, Zn, Cu, Mn); sugar beet root also contains betaine, polyphenolic compounds acid, vitamins, especially B-group vitamins, and significant quantities of soluble and insoluble fibre, having, according to available scientific and expert studies, a positive effect on reducing glycemic load (glycemic index), lowering blood cholesterol, having prebiotic effect and at the same time helping to reduce the volume of food eaten and caloric intake.

The limiting factor for the use of whole sugar beet roots (including their non-sugar portions) in food products is the extremely rapid deterioration of sensory quality and spoilage of roots after disrupting their tissues (degradation), but especially the unfavourable typical negatively perceived earthy taste and aroma of sugar beet products.

There are currently several ways of processing the entire root of sugar beet to produce products that are a nutritionally valuable and functional food sweetener and provide an alternative to processing sugar beet as a source of sugar.

In the application RU2011122992, the entire root of sugar beet is processed into a paste with a moisture content of 55% to 65% by weight, as an additive to food products. Adverse substances and odour were eliminated by mechanical separation of tissues and treatment in an acidic environment. However, mechanical separation is not a sufficiently precise method, and the resulting product is still loaded with sensory negative substances. A disadvantage of this solution is also insufficient stabilisation of the system against its own enzymatic oxidation and degradation, which can lead to oxidative degradation of the product when exceeding paste drying temperatures above 65° C. and pressure above 15 kPa. Another disadvantage of this process is the high energy and process cost in producing the product, due to the use of high pressure live steam as well as the enzymes added in the process.

A very similar approach to sugar beet processing is described in the application WO2018203856, in which whole, washed sugar beet roots were cooked with water, steamed, roasted, or processed by heating with microwave radiation at a temperature of 150° C. to 350° C. A disadvantage of boiling sugar beet roots is also the leaching of nutrients, minerals and sugars into the solution in which the roots are boiled, and thereby losing valuable substances in the process. The long thermal processing time of sugar beet results in a high energy cost of the process. Short thermal treatment on the other hand does not provide sufficient sensory quality of the products for wider food applications.

In the application SK501162014, whole sugar beet root is processed into sugar-fibre products usable as alternative sweeteners. The preparation procedure consists in mixing the sugar beet material with 0.015% to 3.0% by weight of sulphite and then diluting the mixture with water in a 1:1 to 1:10 ratio at pH 3 to 6. The mixture was then heated to 102° C. to 124° C. for 2 minutes up to 60 minutes at a pressure of 102 kPa to 150 kPa and subsequently drying the material at a temperature of 50° C. to 180° C. The disadvantage of this method is the use of a high amount of sulphites.

Also, the quality of the product was still not without sensory defects.

Rapid heat treatment of sugar beet with live steam with its subsequent stabilisation with additives in order to limit the degradation of sugar beet is known, for instance, from RU2292166 or JPH06303922.

Other methods of the state of art use high doses of preservatives, and/or chemical treatment in combination with heat treatment of the roots. These approaches are generally more costly, with the pollution of the products with the residues of chemicals used, such as sulphites, peroxides, acids, bases, and others. The final products still do not have sufficient sensory quality.

### SUMMARY

One objective of the present teaching is to find a method of processing sugar beet under which there is no degradation of the sugar beet material in the tissues after their disruption in the course of processing, or where degradation changes take place only to a minimal extent with no manifestation of the negative changes in taste, aroma, colour and nutritional value in the final products under such method. In this way, the high quality and quantity of constituents, including phenolic compounds, are maintained in the products produced, and there is no change in the colour of the material or the intensification of negative tastes and odours in the sugar beet products obtained.

The products obtained by the method under the present teaching have a significantly improved sensory profile and a reduced proportion of negative sensory substances beyond the limit when they are already undetectable by the human senses. At the same time, the products retain a high original content of fibre, minerals, vitamins, betaine, carbohydrates, and sugars. The products retain a significant proportion of phenolic compounds and amino acids. In this way, it is also possible to produce products in shades of white, which has not so far been possible without chemical bleaching. The products obtained in this way are also stable and do not lose their food quality even after repeated exposure to heat, moisture, or atmospheric oxygen.

The products can be used in the food industry as a sweetener and/or fortifier, where they reduce the glycaemic index in food when applied to foodstuffs.

It is known that after disrupting the tissues of the sugar beet roots the colour of the sugar beet material changes in the presence of gaseous oxygen. In addition, there are also changes characterised by a negative intensification (deterioration) of tastes and odours. Negatively perceived taste and off-odours are a natural part of the sugar beet plant (e.g., geosmin). After disrupting the tissues of sugar beet roots, but especially during its processing, the sensory profile of the material deteriorates and the negative taste and aromatic characteristics of this material increase (intensify). These reactions are part of the degradation processes of sugar beet material obtained after disrupting the tissues of whole sugar beet roots.

The method under the present teaching simultaneously prevents the degradation and oxidation of the sugar beet material also without the need for the use of reducing agents such as sulphites, or with their use in only a significantly reduced amount compared to the state of the art. The resultant product is thus not loaded with additives that would disadvantage (limit) its further application in food industry.

Compared to the current state of the art, the energy costs for production are reduced by at least 25%, resulting in a reduction of the total production costs of the final product.

An advantage of the method under the present teaching is also the increase in the yield of products from whole sugar beet root.

Moreover, the presented solution also deals with adapting the quality parameters of the products (concentrates and preparations) obtained from sugar beet to the individual needs of food producers. According to the present solution, the products are individually modified in order to obtain, after a given specific treatment, more preferable properties for the production of a specified group of foods and/or the fortification of products with specified functional properties.

This method of production prevents the deterioration, i.e. degradation, of the sugar beet material taking place as a natural process after disrupting the tissues of the sugar beet roots and at the same time eliminates the sensory negative flavours and aromas of sugar beet in the products.

Under the present teaching, degradation of material means the processes and reactions that take place in the tissues of the sugar beet root and its varieties almost immediately after tissue disruption, with the external demonstration of degradation being the colour change of the sugar beet material in grey to black colour shades, increase in the concentration of oxidation products and products that impair the sensory quality of the material and cause the intensification of negative tastes and aromas in the material due to changes after tissue disruption compared to fresh sugar beet, thereby significantly reducing the sensory and nutritional quality of products. Degradation also means a reduction in the concentration of nutritionally important substances, especially selected amino acids, and total polyphenols.

Where the term “material” in the context of this application means the material of sugar beet after disruption of the sugar beet root's tissues, usually by mechanical action. The material is considered also an already-peeled sugar beet root.

It is known that gaseous oxygen in direct contact with the material initiates oxidation reactions and discoloration in the material. This process is one of the main degradation mechanisms in the context of the present teaching, but not the only one. Oxidation by atmospheric oxygen is enzymatically catalysed by polyphenol oxidases. It is also known that enzymatic degradation of the material is accelerated by a change in pH and an increase in temperature. However, non-enzymatic material-related reactions are also involved in degradation reactions, the exact mechanism of which is not fully understood.

Surprisingly, we have found that the material's degradation can also be initiated and/or accelerated by the presence of electromagnetic radiation with a wavelength of 200 nm to 1100 nm, in particular radiation with a wavelength from 200 nm to 420 nm, subsequently during processing in the presence of radiation from 200 nm to 420 nm degradation changes can also be initiated by radiation with a wavelength from 550 nm to 650 nm.

The radiation of listed wavelength is partially absorbed by the material and serves as an activation energy for the initiation and acceleration of degradation changes.

In order to prevent or slow down the degradation of the material by radiation, the radiation energy incident on the material before the inactivation step and emitted at the aforementioned wavelength spectrum must be as low as possible, at most below 300 mJ cm⁻², preferably below 150 mJ cm⁻², even more preferably below 50 mJ cm⁻², most preferably below 25 mJ cm⁻². It is preferable that the radiation intensity of the above listed wavelength spectrum does not exceed 0.040 mW. cm⁻², preferably be below 0.015 mW cm⁻², even more preferably below 0.010 mW cm⁻². It is most preferably that the disintegrated material is not exposed to such radiation whose energy emitted in the wavelength spectrum from 200 nm to 420 nm does not exceed 40 mJ cm⁻² until the moment when the moisture content in the material falls below 30% by weight, or up to the inactivation step.

The amount of radiation energy required to initiate and/or accelerate degradation may vary depending on the sugar beet variety, the stage of harvest, as well as the growing conditions. Another factor influencing the rate of degradation is the naturally occurring free water content in the material after disintegration. The water released from the disrupted tissues creates a diffuse environment in which the rate of degradation reactions increases, at the same time the concentration of substances originating from the tissues that participate in the reactions also increases. With reference to the findings, the value of the radiation energy can vary from 3.0 mJ cm⁻² up to 300.0 mJ cm⁻², depending on the growth stage and harvest period, the free liquid water content in the material, the temperature of the material and the degree of tissue disruption.

At temperatures of 0° C. to 80° C., the degradation due to the effect of oxygen is much more intense than the degradation due to the effect of radiation. However, we found that in the absence of light radiation of the aforementioned wavelengths, the intensity of material's degradation is lower only due to the effect of oxygen—beyond the framework of simply deducting the intensity of radiation-based degradation.

The most advantageous solution, though, remains the prevention of the access of both oxygen and radiation of the aforementioned wavelengths to the material.

The rate of degradation of the material depends on the thermodynamic temperature of the material, on the content of free liquid (water) in the material and on the concentration of substances entering degradation reactions originating from tissue cells that were released into the free liquid during tissue disruption.

Free liquid means the portion of sugar beet fluid that is released from the tissues after their disruption.

As the temperature increases, the intensity and rate of degradation increases until a temperature of about 75° C. to 80° C. has been reached. At a temperature of 80° C.±5° C. or higher, thermal inactivation of enzymes, polyphenol oxidases, catalysing oxidative changes, which are one of the initiating factors of the material's degradation process, occurs.

Thus, the intensity of degradation logically increases with the degree of damage to tissue cells. When tissues are damaged, cell juices are released, which contain a complex of substances responsible for degradation of the material (degrading substances). The higher the concentration of degrading substances in the free liquid, the faster and more intense the degradation of the material. In other words, the more the tissues are disrupted, the faster the material needs to be inactivated.

We have also found that the polarity of the free liquid in the material is a significant factor influencing the intensity and course of degradation reactions in the material. By reducing the chemical polarity of the free liquid, there occurs a significant slowing or even stopping of degradation processes in the material—the inactivation. Where a significant slowing means that the degradation processes are slowed to such an extent that their effect on the sensory and nutritional properties of the resulting products under the method of the present teaching is negligible.

The method under the present teaching comprises the step of inactivating the sugar beet material. It is a step aimed at stopping the degradation reactions of the material, improving, and stabilising the organoleptic (taste, aroma), nutritional and overall sensory properties of sugar beet material (colour).

The reduction in chemical polarity is achieved by mixing the material with one or a number of alcohols selected from the group of alcohols containing one to four carbon atoms in the molecule (preferably one to three carbon atoms in the molecule) and one hydroxyl group (monohydroxy alcohols). These are substances such as methanol, ethanol, propanol, tert-Butyl alcohol. Most preferable is the use of ethanol.

Where the concentration of alcohol in the liquid phase of the mixture must be at least 60% by volume, preferably above 70% by volume, most preferably 85% by volume or more. The liquid phase of the mixture under the present teaching means the total amount of liquids in the mixture of the material and alcohols (total water content in sugar beet+added solution of alcohol and water, optionally only pure alcohol). The concentration of the solutions of alcohols (before their mixing with the material) is preferably at least 70% by volume.

The temperature in the inactivation process must be such that the liquid phase of the mixture is in the liquid state, from which it can be transferred into the gaseous state during the course of the process. In practice, temperatures from −15° C. to 180° C. are permissible, but more preferably these temperatures range from 0° C. to 160° C., still more preferably from 20° C. to 140° C., and most preferably from 40° C. to 125° C. Inactivation takes place more intensively at temperatures from 70° C. to 180° C., or potentially from 85° C. to 180° C. A temperature range from 70° C. to 120° C., or potentially from 85° C. to 105° C. is preferable for pertaining the solid portion of products in paler shades. Increasing the temperature speeds up the inactivation processes. At higher temperatures above 100° C. may cause caramelisation to the material. Caramelisation may in certain cases be desirable for the use of the products, in others not.

The mixture must be maintained under the above conditions until a technically uniform concentration of alcohols has been achieved in the entire volume of the mixture.

In the case of the material disintegrated into a paste, technically the same concentration of alcohols is achieved in the entire temperature range (−15° C. to 180° C.) in the entire volume of the mixture almost immediately after mixing. The analytical differences between the concentration of alcohols in the liquid surrounding the paste particles and the concentration of alcohols in the paste particles are negligible in this case. The liquid volume of the mixture can be obtained by filtration as a liquid filtrate.

According to the preferred embodiment, the material disintegrated into a paste can be inactivated for the period of 0 minutes to 10 minutes across the whole temperature range.

In case of whole roots and at the threshold temperature of −15° C., technically the same concentration of alcohols is achieved in the entire volume of the mixture with a holding time of 15 days to 6 weeks, depending on the size of the roots. At sub-zero temperatures, the roots freeze and the process slows down significantly, so this procedure is not preferable. In the case of whole roots and at the threshold temperature of 180° C., technically the same concentration of alcohols is achieved in the entire volume of the mixture with a holding time of 45 minutes±15 min, depending on the size of the roots. It is known that when the threshold temperature is reached, the originally liquid phase is evaporated and in order to reach a temperature of 180° C. the process must take place in a closed space at elevated pressure (e.g., in a pressure vessel).

In general, it applies that the holding time in step (ii) of inactivation decreases proportionally with increasing temperature and increases proportionally with increasing particle size.

Inactivation of whole roots at low temperatures is ineffective. Therefore, it is preferable that whole roots are inactivated at a temperature of 80° C. to 180° C. for 30 minutes to 600 minutes, depending on the size of the roots.

The inactivation process is preferably carried out in a closed space. When the mixture is heated in a closed space, the pressure in the space increases and thus the mixture heats up faster. In this way, alcohol losses (by evaporation) are also reduced.

In the method under the present teaching, it is not necessary to dilute the material with water. A sugar beet root contains approximately 75%±5% by weight of water. During disintegration, part of the water is released from the sugar beet tissues and part remains in the tissues. When mixed with alcohols, both these portions of water (portion from sugar beet and possibly also portion from added alcohol) are part of the liquid phase of the mixture of the material of sugar beet and alcohols.

The material-to-alcohol mixing ratio is used to control in a targeted manner the concentration of alcohol in the mixture and the polarity of the liquid phase in the mixture. With an alcohol concentration in the liquid phase of the mixture above 60% by volume, there occurs a sufficient reduction of degradation processes. Significant reduction of degradation processes occurs at alcohol concentrations above 70% by volume.

The results showed that by increasing the concentration of alcohols in the liquid phase of the mixture the proportion of carbohydrates, minerals and betaine from sugar beet dissolved in the liquid phase decreases, which is beneficial, since it limits, or prevents these substances from entering the liquid phase. Conversely, the proportion of nutritionally disadvantageous substances (antinutritional substances) and the proportion of sensory negative substances dissolved in the liquid phase increases with increasing concentration of alcohols in the liquid phase of the mixture, thus eliminating them in the products obtained from the solid phase. Substances containing phenol that have a positive effect on the human body also enter the liquid phase. These can be obtained from the liquid phase in the alcohol regeneration step, preferably under reduced pressure and at a temperature below 90° C. It is known that these substances can be obtained by extraction with alcohols, but we have found out that if the material does not undergo degradation reactions, the extracts of phenolic substances are much higher. The mentioned trends in solubility of individual fractions depend not only on the quantity of alcohols in the mixture but also on the type of alcohol used.

The alcohol-to-mass ratio determines the effectiveness of inactivation. The material and the alcohol can be mixed in a weight ratio of 2:1 to 1:20, using alcohol solutions of a concentration exceeding 70% by volume. In terms of the efficiency of inactivation of degradation reactions, it is preferable to use a weight ratio of 1:4 to 1:5 (material:alcohol), using alcohol solutions of a concentration exceeding 85% by volume, and more preferable is the weight ratio of 1:1.5 to 1:4 (material:alcohol), using alcohol solutions of a concentration exceeding 90% by volume.

It is beneficial if the material is inactivated using an alcohol solution of a higher concentration (e.g., above 90% by volume) and subsequently, after obtaining the liquid phase, a solution of an alcohol concentration exceeding 70% by volume is repeatedly used to inactivate further material which has not yet been inactivated. With each repetition of inactivation using the solution of alcohols, which is the liquid phase from the previous inactivation of the material, the concentration of alcohol in the solution of the subsequently obtained liquid phase decreases due to its enrichment by the proportion of water from the material during inactivation. The number of possible reuses of the liquid phase in the inactivation step, as an alcohol solution, is limited by the concentration of alcohols in the created liquid phase which is at least above 60% by volume, preferably above 70% by volume, best 85% by volume or more.

The achieved concentration of alcohol in the liquid phase of the mixture is decisive for inactivation. For the proper course of the inactivation process to take place, it is important that a minimum alcohol concentration of 60% by volume, preferably 70% by volume or more, is achieved. At lower alcohol concentrations, the material is not stable against degradation.

The same applies also if prior to its inactivation the material is disintegrated and pre-dried according to the method under the present teaching. In case where the material is pre-dried to more than 80%, for performing inactivation it is beneficial to use a weight ratio of the material's dry matter to alcohol of 3:2 to 1:2.

The speed of the inactivation process also depends on the particle size of the material. The smaller the material particles, the faster the speed of the inactivation process.

According to the preferred embodiment, the mixture can be tempered after the inactivation step—kept at a certain temperature for a certain time (beyond the aforementioned holding time for inactivation). Tempering the mixture at a specific temperature promotes changes whose course in the mixture depends on the thermodynamic temperature under the given conditions.

Tempering can also take place at negative temperatures (below 0° C.) in winter seasons, with a minimum of energy outlaid for the process. At low temperatures (below 10° C.) tempering is prolonged even to several hours to achieve a similar result to that obtained at higher temperatures.

Preferably, the mixture may be stirred during tempering. Preferably, the tempering is carried out at temperatures from −15° C. to 135° C. for a period of holding time of up to 180 minutes, preferably at temperatures from 80° C. to 135° C. for 1 minute to 10 minutes.

According to the preferred embodiment, the mixture is tempered at the end of the inactivation, with the temperature of the mixture being maintained for 1 minute up to 60 minutes in the temperature range from 80° C. to 135° C. in a closed space under constant stirring. Preferably, the temperature is then increased above 80° C. with a holding time of less than 30 minutes and/or the temperature is increased up to 120° C.±15° C. with a holding time of less than 60 minutes. After reaching the required temperature and holding time, the produced vapours will begin to be removed outside the tempering equipment. The captured vapours are directly distilled and rectified to produce alcohol for subsequent use.

When the evaporation temperature of the liquids is reached, the polarity of the liquid phase of the mixture grows continually as the evaporated portion of the alcohol is greater than the evaporated portion of water. This mechanism also selectively changes the degree of solubility of individual substances and portions of sugar beet in the liquid phase. The escaping vapours at a temperature exceeding 80° C., in particular in the range from 100° C. to 125° C., always contain a proportion of naturally occurring sensory-negative substances from sugar beet roots dissolved in the liquid phase of the mixture before the start of evaporation. The process of removing sensory-negative substances is thus intensified with the achievement of the stated temperature ranges during evaporation.

The tempering process is terminated when the liquid phase in the mixture drops below 60% by weight, or after the alcohols are evaporated from the mixture, where the residual alcohol in the liquid phase in the mixture may be up to 5% by weight, preferably below 1% by weight.

Before, during or after the inactivation step, the sugar beet roots must be disintegrated. Disintegration of sugar beet roots is a process aimed at dividing the sugar beet root into parts. Sugar beet roots are disintegrated, for example, by slicing, cutting, grinding, grating, or homogenising to a fine paste. Paste means a material that behaves as a heterogeneous liquid (liquid suspension) at a temperature of 20° C. under atmospheric conditions. The paste preferably has a particle size of less than 1 mm, preferably less than 0.25 mm.

In the method under the present teaching, the roots are disintegrated into a material containing particles where at least one of the particle dimensions is less than or equal to 50 mm, preferably less than or equal to 10 mm, even more preferably less than or equal to 5 mm, and most preferably less than or equal to 3 mm. The sugar beet material can also be in the form of a paste.

Where if the disintegration of the roots occurs before the inactivation step, at least one of the following conditions (a) to (d) must be adhered to:
a) the time between root disintegration and inactivation is at most 24 hours and shortens proportionally with the increasing surface of the disintegrated material so that disintegration into a paste is directly followed by inactivation; and/or
b) during or immediately after disintegration, the disintegrated material is shock-heated to a temperature of at least 80° C., preferably to 80° C. to 230° C., more preferably to 80° C. to 180° C., most preferably to 90° C. to 110° C.; and/or
c) during or immediately after disintegration, the disintegrated material is pre-dried using a flow of gas (gases) at a temperature of 25° C. to 180° C., preferably from 85° C. to 120° C., until reaching the moisture content in the material of at most 50% by weight, where, if the gases contain at least 12% of oxygen, then the gas flow rate in the drying space must be 5.0 m.s⁻¹ to 40 m.s⁻¹, preferably 5.5 m.s⁻¹ to 20 m.s⁻¹, even more preferably 7.5 m.s⁻¹ to 15 m.s⁻¹. The gas used is preferably air, still more preferably air with oxygen content reduced to a concentration value below 12% by volume, nitrogen or a mixture of nitrogen and carbon dioxide, most preferably carbon dioxide; and/or
d) all processes from disintegration to inactivation/tempering (inclusive) take place:
   in a controlled atmosphere, preferably in a controlled atmosphere with increased carbon dioxide content, or in an environment with reduced pressure, where in both cases the oxygen content is reduced by at least 40%, preferably by 60%, most preferably by 80% or more than the oxygen content of the Earth's atmosphere; and possibly
   where the intensity of radiation of wavelengths from 200 nm to 420 nm and from 550 nm to 650 nm incident on the surface of the material moves in values below 0.040 mW cm⁻², preferably below 0.015 mW cm⁻², so that the value of energy emitted in the said spectrum of light radiation is at most up to 300 mJ cm⁻², preferably up to 150 mJ cm⁻², even more preferably up to 50 mJ cm⁻², most preferably up to 25 mJ cm⁻².

By heating the inactivated material up to a temperature of at least 80° C. (preferably above 90° C.), the elimination of enzymes involved in the degradation of the material is achieved, thus limiting the degradation of the moist material, at the same time the material can be heat-dried.

Preferably, the material is heated up to a temperature of at least 80° C., preferably 80° C. to 230° C., 80° C. to 180° C., 85° C. to 160° C., most preferably 90° C. to 110° C. before disintegration. The heating temperature of the material is limited from above only by the thermal decomposition of the material, starting for the individual components of the material at a temperature of 180° C. to 230° C. and continuing at higher temperatures.

According to the preferred embodiment, the disintegration step can be performed directly in the inactivation step, thus significantly limiting the initiation of the material's degradation due to the effect of oxygen and/or the disintegration step is performed in an environment with reduced oxygen content and/or reduced intensity of light wavelength radiation as described above. A combination of all three conditions is most preferable.

It is also possible to inactivate whole roots and only then disintegrate them, but in view of the higher energy requirements, it is more beneficial for the disintegration to take place before or during the inactivation step.

The final step of the process under the present teaching is the removal of the liquid phase from the mixture to form a product with a dry-matter content of 40% by weight up to 100% by weight, preferably from 60% by weight up to 99% by weight.

Removal of the liquid phase from the mixture can be accomplished by various methods known in the state of art. For example, by centrifugation, drying, separation and subsequent drying.

Drying is carried out in dryers or in combination with extrusion. Drying in dryers may use microwave irradiation, and/or vacuum drying under reduced pressure and/or fluid bed drying in a flow of air or gas, or adiabatic expansion (e.g., extrusion process of the material) or contact heating, alone or in combination. The extrusion process also changes the properties of the products, in particular it increases the water binding property and improves the solubility of the products.

It is preferable to modify the properties of the material by the extrusion process and at the same time to completely dry the material in one production step if the moisture content of the material is 5% by weight up to 25% by weight.

Under the preferred embodiment, the liquid phase can be removed by combined drying, where the mixture with the proportion of the liquid phase exceeding 50% by weight is first dried on one equipment, by intensive evaporation of the liquid phase, and subsequently the product is completely dried at another equipment to the desired value of dry matter.

According to the preferred embodiment, the material is dried at atmospheric pressure or vacuum (from 1.0 kPa to 60 kPa) at temperatures up to 160° C., even more preferably 40° C. to 120° C. To achieve a lighter colour of the resultant products, it is preferable to use in the final stages of drying, where the water content of the mixture is below 60% by weight, temperatures up to 100° C.; the material dried in the final stages of drying at 120° C. or higher may in some cases caramelise (caramelisation may be desirable in certain uses of the products).

Alternatively, the liquid phase can be removed from the mixture by separation and subsequent separate drying of the individual phases.

By increasing the concentration of alcohol in the liquid phase of the mixture (in the inactivation step), in the process of phase separation a higher portion of dry matter in the solid phase is obtained compared to the portion of dry matter in the liquid phase. This is beneficial, because the process for obtaining the product from the liquid phase is more energy and process intensive than obtaining the product from the solid phase, which only undergoes final drying after separation.

Under the preferred embodiment, prior to the separation the mixture can be cooled to a temperature below 30° C., thus also increasing the yield of the solid phase in the separation process as well as reducing the energy requirements. Preferably, before and during the separation process of the mixture, the mixture is maintained at a temperature between −15° C. to 30° C.

The solid phase formed after separation of the mixture is dried as described above to form a product with a dry-matter content of 40% by weight to 99% by weight, preferably of 60% by weight to 98% by weight. Subsequently, the product can be processed by grinding, and/or fractionation and/or hydrophobisation and/or washing in any order of these steps.

The liquid phase formed after the separation of the mixture can then be treated by winterization. Optionally, the liquid phase is transferred to recover the alcohols and the residue after removing the alcohol is dried to form a product with a dry-matter content of 40% by weight up to 99% by weight, or is crystallised.

The recovery of the alcohols produces a concentrated alcohol suitable for its repeated use in the process and at the same time produces a by-product, usually a distillation residue, which can then be dried (as mentioned above) or crystallised. After drying, it is preferable that the product thus obtained be further washed, then to separate it again, where the resulting solid portion after separation is dried to make the product and the liquid portion is recovered again. The product thus obtained is subsequently suitable for further food-processing use.

The by-product can be processed by a crystallisation process. The completed crystallisation process is followed by separation to form a solid and a liquid phase. The liquid phase can then be further dried and washed.

Crystallisation is a process by which the concentration of substances dissolved in the solution is increased by removing, largely evaporating, the liquid phase from the mixture to produce a saturated solution, which mostly at reduced temperature becomes a supersaturated solution. From the supersaturated solution of sucrose, it is then possible, by initiating crystallisation, to obtain sucrose as a solid substance (crystals) that can be separated from the mixture, producing a solid fraction (crude crystalline sucrose) and a liquid fraction. By repeatedly concentrating the obtained liquid phase, the crystallisation can be repeated or combined with drying. The dried liquid fraction after crystallisation may be washed with alcohol.

Winterization of the liquid phase is a step aimed at obtaining a solid portion of dry matter from the liquid phase due to the effect of low solubility of the solid portion at a low temperature in the liquid phase. During the winterization, it is preferable to lower the temperature of the liquid phase to −30° C. to 10° C.

The precipitated solid portion of dry matter is separated after winterization (second separation) and after separation it is dried to create a product with a dry-matter content of 40% by weight to 99% by weight.

After the second separation, the dry matter is dried in the same manner as described above. The only difference is in the dried material, which is a different fraction in the process of sugar beet processing.

The liquid phase is preferably removed after the second separation for the recovery of the alcohols, and is treated in the same manner as after the first separation.

The method under the present teaching may also comprise other optional steps which further improve the quality of the products, or they can be used to obtain products with specialised chemical-physical properties suitable for the production of specific foods.

According to the preferred embodiment, the cleaned sugar beet roots can be peeled prior to their disintegration or inactivation, thereby reducing the portion of dark-coloured particles in the resultant products. It is also known that the concentration of sensory-negative substances and substances causing material's degradation generally decreases in the roots from their surface to their centre. It is preferable to avoid degradation also during the peeling procedure of the roots, e.g. by reducing the air pressure, reducing the oxygen content by a controlled atmosphere, reducing the intensity of solar radiation, rapid heat treatment at temperatures exceeding 85° C. with dry heat, or rapid drying of the surface of the resulting material.

To prevent material's degradation (stabilisation), one or several of the following steps (A) to (C) may be performed.

(A) In the disintegration step, add Na₂S₂O₅ and/or K₂S₂O₅ directly to the material in an amount up to 0.05% by weight, and/or NaNO₂ and/or KNO₂ in an amount up to 0.95% by weight. The sodium and potassium salts are added in solid crystalline chemically pure form.

It is preferable that the amount of sulphites be up to 0.05% by weight, even more preferably up to 0.015% by weight, or the amount of nitrites is up to 0.50% by weight, based on the weight of sugar beet entering the process. The content of these substances is a limiting factor for the use of the products in the food industry and in terms of nutritional value, the presence of these substances in the products is not beneficial.

(B) It is also possible to reduce the oxygen concentration by at least 40% throughout the process until inactivation (inclusive), ideally though by 90% or more, compared to the oxygen content in the atmosphere, for instance, by applying a controlled atmosphere.

(C) It is also possible to reduce throughout the process until inactivation (inclusive) the total radiation energy of a wavelength from 100 nm to 1100 nm, in particular from 200 nm to 420 nm, and/or from 550 nm to 650 nm, to a value of less than 300 mJ cm⁻², preferably less than 50 mJ cm⁻², most preferably below 25 mJ cm⁻².

The material can also be pre-dried prior to inactivation—ideally to 50% by weight up to 99.9% by weight of dry matter in the material. We found that under 30% by weight of moisture content, degradation reactions are stopped in material due to the lack of liquid water in the material.

Pre-drying reduces the demands on the amount of alcohol used in the inactivation process and increases the yield of the products. Pre-drying also partially stabilises the material against degradation.

According to the preferred embodiment, immediately after disintegration, the material is heated up with dry heat to a temperature of 25° C. to 120° C., preferably 85° C. to 105° C., until reaching the aforementioned dry matter values.

If air with an oxygen content above 12% by volume is used for pre-drying, then the material is dried immediately after disintegration at an air flow rate of 5.0 ms⁻¹ to 40 ms⁻¹, preferably from 5.5 ms⁻¹, even more preferably from 7.5 ms⁻¹, where the minimum air temperature can be: 25° C., 30° C., 35° C., 45° C. at relative humidity of the drying gas from 0% to 45%, 0% to 65%, at most up to 85%. At low air temperatures, the air flow rate must be increased proportionally so that at 25° C. the air flow rate is at least 12.0 ms⁻¹ or more.

Preferably, the pre-drying step is performed simultaneously with steps (B) and/or (C), especially if at least one of the particle dimensions formed after disintegration is less than or equal to 3 mm.

During the material's disintegration to the paste, it is necessary to process the material during pre-drying in an environment with a controlled atmosphere and reduced radiation intensity of the specified wavelengths, where the oxygen concentration in the environment is less than 8% by volume.

After pre-drying and before inactivation, it is possible to grind the material with a dry-matter content exceeding 85% by weight, preferably above 90% by weight, to a particle size below 1.5 mm, and then fractionate the formed particles and only then inactivate it. The process of mechanical fractionation of the pre-dried material by particle size proceeds faster with dried material that has not been inactivated.

During the fractionation (dividing) of particles, it is beneficial to use sieves arranged according to the size of the mesh openings with a size of 25 μm to 500 μm, preferably a series of sieves with a mesh size of 50, 100, 150, 200, 250, 400 and 500 μm. The individual fractions can be repeatedly ground and divided by size and/or density and air drift threshold of particle. After each repetition of grinding and fractionation, fractions of material are formed where each of the formed fractions contains a different chemical (substance) composition that differs from the other fractions formed.

By comparing the chemical composition of fractions obtained before and after inactivation from the dried material we found that there are smaller differences in the content of mono- and disaccharides, minerals, and polysaccharides of individual fractions if fractionation is performed using the same procedure before inactivation than after inactivation with alcohols. Fractionation after the material's inactivation makes it possible to achieve higher differences in the qualitative composition of the individual fractions obtained by the same fractionation procedure. Differences are also found in the chemical composition of the fractions when comparing the same fraction obtained by fractionation before and after inactivation (the representation of each substance from sugar beet dry matter in the product fractions varies). The material which has not been stabilised in the disintegration step is pre-dried at a temperature of 25° C. to 180° C., more preferably from 85° C., most preferably from 95° C., preferably simultaneously with steps (B) and (C). Subsequently, the material can be fully dried, to a moisture content of up to 1% by weight.

Pre-drying can also be performed by combined pre-drying, in the same way as in drying.

It is advantageous if the temperature during the pre-drying and/or drying process is regulated on the basis of the material's moisture content and/or material's particle size, where at higher moisture or particle size the material is initially dried at higher temperatures above 100° C. and when the moisture content in the material drops, the drying temperature is reduced within the ranges indicated under the present teaching.

Due to the partial elimination of degradation changes and product specialisation, the mixture in the disintegration step can be acidified with organic or inorganic acids (especially citric acid, malic acid, acetic acid, lactic acid, tartaric acid, hydrochloric acid, phosphoric acid, and others) to adjust the pH of the material to a value in the range of 2.0 to 4.9, preferably from 2.0 to 4.2. At the same time, by adjusting the pH, depending on the type of acid used, the taste and the overall sensory profile of such a product can also be adjusted.

The vapours generated in the step of inactivation, tempering, and drying can be captured for the recovery of alcohols at atmospheric pressure or under vacuum up to 40 kPa, preferably at a pressure below 9.9 kPa. This will reduce losses and increase the proportion of recycled alcohols for further use. The removal of the vapours for the recovery of the alcohols can be carried out at every step in which the produced vapours contain alcohol.

According to the preferred embodiment, after the disintegration step (especially before inactivation or in the inactivation process), the material/mixture can be treated with ultrasound (sonication).

It is advantageous if the material is disintegrated into a paste prior to sonication and subsequently stabilised. If the material does not get stabilised following its disintegration, then the sonication process prior to inactivation takes place at an oxygen concentration reduced by at least 80%.

The material/mixture is sonicated at frequencies from 10.0 kHz to 40 kHz for 1 minute to 6 hours at a sonication power from 30 J/g to 4500 J/g of mixture.

Sonication is preferably performed at ultrasonic frequencies from 15 kHz to 35 kHz, most preferably from 18 kHz to 26 kHz at a sonication power from 35 J/g to 3000 J/g.

According to the preferred embodiment, in order to reduce its viscosity, the mixture can be heated up during the sonication and subsequently maintained at a temperature of 50° C. to 85° C., preferably 60° C. to 70° C. The temperature is maintained by an external energy source.

Sonication increases the solubility of substances in water while reducing the viscosity of the material. We found that sonication can also modify the physical-chemical properties of products. With increasing sonication performance, the organoleptic properties of the material are improved, in particular the negative taste and aroma are removed. Sonicated products dry faster compared to unsonicated ones and have a finer structure after drying and grinding. The degree of solubility in water and the proportion of soluble fibre changes.

According to the preferred embodiment, after drying, the product may be washed.

The aim of washing is to reduce the colour intensity towards the lighter hues of the product and to remove residual negative organoleptic substances.

Washing is carried out by repeating the step of mixing with the alcohols in a ratio of 4:1 to 1:5, preferably 2:1 to 1:2 (product:alcohol), with the minimum concentration of alcohol solution of 70% by volume. Subsequently, the mixture is heated up under constant stirring to a temperature in the range of 0° C. to 90° C., and the temperature is maintained from 0 minute up to 600 minutes. Subsequently, the mixture is separated and further processed as described in the main processing method.

All of the above-listed optional steps can be freely combined.

The product, after drying to a dry matter value of 60% by weight, is in the form of a paste which, in order to improve its shelf-life, is preferably packaged in hot-filled air-tight containers.

The product after drying, or the material after pre-drying and before inactivation, with a dry-matter content above 80% by weight, preferably above 90% by weight of the dry matter, in the form of a solid material, can be subsequently adjusted by grinding to the desired particle size, where the grinding results in a material in the form of powder. After grinding, it is beneficial to divide the material into fractions on the basis of the particle size on sieves or by the particle air drift method.

Subsequently or alternatively, the product/material may be hydrophobized by mixing it with fats to achieve better resistance to air humidity and limit the hardening of the products in an environment with air humidity.

In the grinding process, in addition to the particle size, the moisture content is also adjusted in the range from 15% by weight to 2% by weight. Intensive grinding causes friction during which the temperature of the materials increases. During grinding, water can be still evaporated from the solid portion, increasing the portion of dry matter in the ground material. The granulation treatment also affects the solubility of the material in water and the viscosity achieved by grinding the obtained material in a mixture with water.

All products produced using the method under the present teaching, except the products obtained from the liquid phase from the distillation residue in the alcohol recovery step, can be fractionated after their grinding in the fluid fractionation step and/or sieve separation by particle size, where the size of the sieve mesh opening regulates the size of the fraction created on and under the sieve. The individual fractions differ from one another in particle size, as a rule also in terms of substance composition and chemical-physical properties. The fractionation step is advantageous for the reason of product specialisation for their use in the production of different types of foods where different requirements are placed on the texture and/or nutritional parameters of the food.

The hydrophobisation process is performed on high-speed mixers, or homogenizers, or by spray application of fats. Finished products with a moisture content below 15% by weight, preferably below 4% by weight in the solid state are mixed with vegetable fats in liquid form (oils) at a temperature up to 60° C., in ratios from 1:2 to 1:50 by weight (oil:product), to form a powder or paste product. The hydrophobised product in powder form always absorbs less atmospheric moisture than the non-hydrophobised product, where the difference in adsorption can be more than 80%. The hydrophobised product with a higher proportion of added fat in the final form of paste showed even more than 90% reduction of air moisture adsorption in 24 hours. Products with a higher proportion of fats were suitable for food products in which there is a high proportion of vegetable fats in the recipe (e.g., chocolate). Conversely, products with a lower fat content were suitable for food products requiring a low proportion of vegetable fats in the recipe (e.g., jams, or bakery products).

The method under the described present teaching creates products with high nutritional and sensory quality, of light stable colour and good functional properties. This method provides products for a wide application in food products. The product does not contain any or only threshold amounts of sensory negatively perceived substances, it is microbiologically and chemically stable.

The products obtained under the method of the present teaching are characterised by a content of mono- and disaccharides in the dry matter of the product (up to 95% by weight) and/or a total fibre content in the dry matter of the product (up to 85% by weight), a content of essential minerals in the dry matter of the product (up to 4.5% by weight), a betaine content (up to 1500 mg/kg of dry matter of the product), content of phenolic substances with antioxidant capacity (up to 5% by weight). The content of substances in dry matter can vary depending on the application of various optional steps of the method under the present teaching. However, the content of substances in the products always depends on the content of such substances in the input the raw material.

### BRIEF DESCRIPTION OF THE DRAWINGS

FIG. 1 is a flow chart describing the process of processing sugar beet according to the presented present teaching.

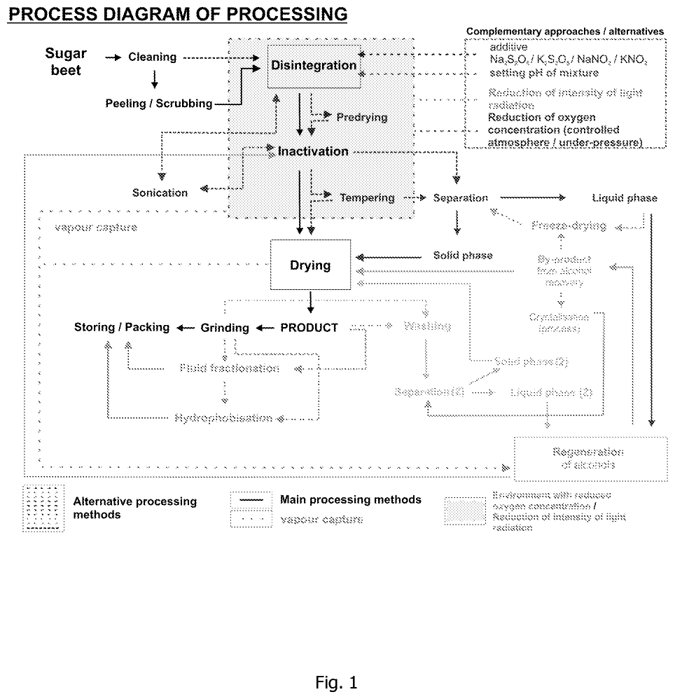

### EXAMPLES OF EMBODIMENTS

### Example 1

A defoliated sugar beet root was cleaned of surface impurities. The whole root was grated to shavings about 10 mm thick. Subsequently, the shavings were mixed with an ethanol solution of a concentration of 95% by volume of ethanol in a weight ratio of 1:1.5 (material:ethanol) and such mixture was homogenised into a fine paste. Subsequently, the mixture was heated to 85° C.±5° C. under constant stirring with a holding period of 10 minutes. The mixture was then cooled down to 25° C. and separated into a liquid and a solid phase.

The solid phase was dried at the temperature of 100° C.±5° C. to reach a final dry-matter content of 92% by weight, while gaining a partial solid phase product (SP1).

The liquid phase was dried under constant stirring at a temperature of 55° C., in a vacuum of 15 kPa±5 kPa. After alcohol evaporation from the liquid phase, a by-product was obtained consisting mainly of an aqueous solution of mono- and disaccharides, minerals and other minor substances originating from sugar beet. This by-product was additionally dried in the vacuum film dryer at a temperature of 100° C.±5° C. and a pressure of 15 kPa±5 kPa to a dry-matter content of 94% by weight. The partial product thus obtained from the liquid phase was further washed—being mixed with 95% by volume of ethanol in a 1:1 weight ratio. The mixture was heated up to 40° C. and separated. After this second separation, the obtained solid phase was dried at a temperature of up to 100° C., producing a partial product from the liquid phase after the second separation (LP1).

Ethanol was recovered from the liquid phase after the second separation at a pressure of 9.9 kPa. The recovery produced a distillation residue (SP2) which was dried, in the same way as the by-product from the liquid phase after the first separation.

Vapours generated during the entire process were captured for the recovery of ethanol.

The solid phase product (SP1) contained in particular higher polysaccharides such as pectin substances, hemicellulose and cellulose from sugar beet which constituted 80%±4% by weight in the dry matter of this fraction. The remaining part of the solid phase fraction comprised mono- and di-saccharides (6%±2% by weight) and in minority further substances retained from sugar beet. The product was white in colour, with no trace of sensory negative substances.

The liquid phase product (LP1) contained in the dry matter especially mono- and di-saccharides (88% by weight), minerals (1.35% by weight), betaine (480 mg/100 g) as well as other minority fractions of substances originating from sugar beet. The product was white in colour of a yellow-beige hue, with no trace of sensory negative substances. The distillation residue after drying (SP2) contained residual sugars and minerals as well as antinutritional and colouring substances, was green in colour and contained a recognisable share of sensory negative substances.

Mixing parts of solid (SP1) and liquid phase (LP1) in different ratios resulted in a product from a whole sugar beet root, with a substance composition dependent on the mixing ratios of the two fractions. For use in the production of jams, the mixing ratio of fractions was about 3:1 (LP1:SP1), for use in wheat bakery products the mixing ratio of fractions was 1:1.

For use for a food recipe, the product's organoleptic and overall sensory parameters did not change even during further processing by processes applied in the production of the final food product (e.g., bakery products, jams, or chocolate materials).

### Example 1.2

As in Example 1, the sugar beet root was processed by disintegration and inactivation under the same process conditions. Subsequently, immediately after inactivation, the mixture was evaporated in a reduced pressure environment at a temperature of 80° C.±5° C., the evaporated alcohol from the mixture was recovered to form alcohol for further use in the processing. After evaporation of the alcohol to a level below 5% by weight in the mixture, the mixture was pumped to a film evaporator where it was dried to a dry matter level of 90%±5% by weight. The product thus obtained had a pale green-beige hue and showed very low, only faintly recognisable sensory-negative odours of sugar beet. The product was subsequently washed with 95% v/v ethanol in 1:1 weight ratio at a temperature of 30° C. for 5 minutes. Afterwards, the solid phase was separated from the liquid phase. The solid phase was dried at 110° C.±5° C. producing the product. The liquid phase was recovered under a vacuum of 9.9 kPa at a temperature of 35° C. to form ethanol with a concentration of 95% by volume and a distillation residue.

The product/concentrate from the solid phase, formed after washing, was of light yellow to light beige colour, with no traces of negative sensory and antinutritional substances. The concentrate contained a portion of simple sugars (mono- and disaccharides) in the dry matter of 62% by weight to 68% by weight, content of minerals of 1.30%±0.12% by weight, represented in particular by K, Na, Mg, Ca, Fe, F, Zn, Cu, Mn. The total fibre content was approximately 18.8%±2.6% by weight (total fibre consisted primarily of: cellulose, hemicellulose, pectin compounds), the betaine content was determined to be 685 mg/100 g±48 mg, the group B vitamins content totalled 14 mg/100 g±1.9 mg/100 g. Substance composition in sugar beet concentrates in repeated experiments was always dependent on the representation of individual substances in sugar beet as a raw material entering the process.

### Example 1.3

A defoliated sugar beet root was cleaned of surface impurities. The root was cut into different length shavings of 30 to 140 mm with a cross-section of approximately 10×20 mm. The obtained pieces were then inactivated by mixing them with 95% v/v ethanol in a 1:2 ratio (dry matter material:ethanol) under constant stirring for 15 minutes. After the expiry of the inactivation period, the mixture was tempered. Tempering included gradual heating under constant stirring to a temperature of 120° C.±10° C. for 30 minutes in a closed pressure vessel. After the holding time, the created vapours were gradually removed from the pressure vessel under constant stirring and were directly rectified by distillation to form alcohol. The evaporation process was completed at the moment when the ethanol content in the mixture dropped below 5% by weight. After completion of the process, the material was disintegrated into a paste and pumped into the vacuum film dryer where it was dried at a temperature of 120° C.±5° C. and a pressure of 20 kPa±10 kPa to a final dry-matter content of 92% by weight.

The product thus formed was, after drying, of a green-beige colour with a low but acceptable content of sensory negative substances. The product was therefore ground to a fine powder with particles below 500 μm and subsequently the product was washed with ethanol at a concentration of 95% by volume, by its mixing in a ratio of 1:2 (product:ethanol). The mixture was heated to a temperature of 85° C. in a sealed vessel for 10 minutes; after the expiry of the holding time, the mixture was cooled down to 15° C. and separated. The solid phase obtained was dried and a temperature of 100° C. in a dryer, the liquid phase, once separated, was used to recover alcohol as in Example 1. After washing, the obtained product was of pale yellow-white colour, the taste of the product following its washing and drying was without any trace of negative sensory substances, with a slight pleasant aroma and flavour of caramelisation of sugars. For use in food recipes, the product's parameters did not change during further processing by the processes applied in the production of the final food (e.g., bakery products, jams, or chocolates). The material composition of the product was in repeated experiments always dependent on the substance composition of the raw material, as was the case of Example (1.1).

### Example 2

A defoliated sugar beet root with a sugar content determined at the level of 14% by weight of the sucrose content was cleaned of surface impurities and roughly cleaned of surface peel. The sugar beet was disintegrated by slicing into 20 mm thick pieces. The material sliced in this manner was immediately divided into several parts and each part was mixed with one of the group of alcohols:ethanol, methanol, propanol, and a mixture thereof, always consisting of two alcohols from this group in a 1:1 ratio. The pieces of sugar beet were subsequently further homogenised in alcohol to form a fine paste.

The alcohol solutions used were tested at two various concentrations, 85% by volume and 95% by volume. The ratio of mixing sugar beet paste with alcohols was 1:1, 1:2, 1:5, 1:10 and 1:15 (material:alcohol).

In one group of samples, inactivation was performed by adding the appropriate alcohol under constant stirring at a temperature of 25° C. In another group of samples, the alcohol-paste mixture was, during the inactivation process, heated up to a temperature of 85° C.±5° C. in a sealed vessel with a holding time of 10 minutes. The inactivated samples of the mixture were tempered by their heating up to a temperature of 110° C.±10° C. in a closed pressure vessel under constant stirring and during the holding time of 10 minutes and 30 minutes. Subsequently a major part of the liquid phase was evaporated from the mixture (to the dry-matter content of 60% by weight) in a film evaporator and additionally dried at temperatures of 100° C.±10° C. with reduced pressure of 20 kPa±10 kPa. With the dry-matter content of 60% by weight, the resultant product was of paste consistency; with the dry-matter content of 92%±5% by weight, a powdery product/concentrate was formed. The obtained product was ground to the desired granulation with a particle size below 1000 μm. The colour of the products obtained after drying was light green to beige, the products with a higher water content were always darker. The colour of the products remained unchanged even after repeated heating. The sensory properties of the products after drying were at the limit of acceptability, with very low odour intensity of sugar beet. The intensity of the negative odour decreased with an increasing portion of alcohol in the mixture added in the inactivation step. Subsequent washing, as in Example 1.3, significantly improved both the colour and sensory parameters of the products. After washing, the resultant product did not change its parameters even during further processing by processes applied in the production of the final food (e.g., bakery products, jams, or chocolates).

Evaporated water and alcohol were collected during the drying process and the alcohol was recovered from the mixture for further use by a distillation and rectification process under vacuum (up to 9.9 kPa). In the process, the vapour energy was recovered and used for heating in other phases of the process. Using 85% v/v alcohol solutions, the most optimal sensory properties of concentrates were achieved at a mixing ratio of 1:5. The propanol (C3) based process was best evaluated in terms of sensory properties, but the ethanol-based process was evaluated most advantageous. At an alcohol concentration of 95% by volume, the most beneficial mixing ratio (sugar beet paste:alcohol) was already 1:2 ratio when using ethanol (C2). When using methanol (C1) or mixtures of alcohols, the sensory parameters were evaluated as worse, in the case of propanol (C3) they were in some cases better, or comparable to ethanol (C2). When methanol was used, the products displayed detectable trace quantities of negative sensory substances of sugar beet, but in the case of ethanol and propanol, sensory negative substances were suppressed to a sensory acceptable limit or beyond the sensory perception limit.

The more preferable inactivation temperature was above 80° C., where the resultant products after washing were always lighter in colour compared to the obtained products with an inactivation temperature of 25° C. After washing, the products at an inactivation temperature of 25° C. were of a darker colour.

The products thus obtained retained nutrients derived from sugar beets as well as the content of polyphenolic compounds which degraded minimally in the process by oxidation scale. In case of material-to-alcohol ratios of less than 1:2 (material:alcohol), the products, following the drying step prior to the washing step, had a perceptible slight discolouration towards the hues of green to beige. All products retained their typical sweet taste. The products were not caramelised and in their dry matter contained a natively high portion of sugar beet dietary fibre (8% to 10%). The products obtained did not contain sulphites, reducing agents or additives. The products obtained did not show any impairment by substances reducing their sensory or nutritional quality. Substances with negative organoleptic properties originating from sugar beets were eliminated in the process and were not sensorially noticeable.

The content of simple sugars (mono- and di-saccharides) in the concentrates obtained reached the level of 62% by weight to 68% by weight, content of minerals of 1.10%±0.15% by weight, in particular K, Na, Mg, Ca, Fe, F, Zn, Cu, Mn. The total fibre content was approximately 19.6%±2.8% by weight (total fibre consisted primarily of: cellulose, hemicellulose, pectin compounds), the betaine content was determined to be 588 mg/100 g±61 mg, the group B vitamins content totalled 10 mg/100 g±1.6 mg/100 g. Substance composition in sugar beet products/concentrates in repeated experiments was always dependent on the representation of individual substances in the raw material entering the process.

### Example 3

In Example 3, the same process as in Example 2 was used, but with the difference that the disintegrated material was, prior to its mixing with alcohols, pre-dried by combined drying, using fluid bed drying in a controlled atmosphere and air at a temperature of 100° C. and an air flow rate of 6.5 m.s⁻¹. The fluid drying in a controlled atmosphere was applied until the temperature of the material has reached 85° C.±5° C., and then the material was dried in a fluid bed dryer to the dry matter value of 60% by weight and 90% by weight. The pre-drying process was carried out at an oxygen concentration reduced by 40%, containing carbon dioxide. The rest of the procedure was the same as in Example 2.

The resultant products had a dry-matter content of 95% by weight. The products had comparable sensory properties, with a shade slightly darker in colour compared to the products obtained without pre-drying. The difference from the resultant products from Example 2 was that the organoleptic quality of the products (especially taste, aroma when consumed) undergoing pre-drying was, already at material-to-alcohol ratio of 1:1, comparable to the quality of the products from Example 2 obtained at higher ratios of added alcohols. The resultant vapours in the tempering process were extracted at a temperature of 110° C.±10° C., deducted directly for recovery in which the alcohol was concentrated to produce solutions with an alcohol concentration of min 80% by volume. The products obtained, after drying to the dry-matter content of 97% by weight, they were subsequently washed. Washing of the products was carried out in a manner that following their drying the products were repeatedly mixed with alcohols in 2:1 or 1:1 ratios (product:alcohol), similarly as in the in activation process. The mixture temperature during washing was 50° C.±10° C. for 10 minutes under constant stirring; the mixture was then cooled down to 20° C. and separated into liquid and solid phases. After separation, the solid phase was dried at a temperature of 90° C.±10° C. to a dry matter value of 97% by weight. The product obtained was lighter in colour, had the same or better organoleptic properties and a comparable substance composition as the products of Example 2. The liquid phase after separation was recovered in order to obtain reusable alcohols. The product contained all substances originating from the raw material, the process stopped the degradation processes and removed the sensory negative components and part of the degradation products causing the colour change in the mixture. The sugar content in the concentrates obtained was 68% by weight, the content of minerals was 1.25% by weight, in particular potassium, sodium, magnesium, calcium, iron, fluorine, zinc, copper, manganese (K, Na, Mg, Ca, Fe, F, Zn, Cu, Mn). The total fibre content was 20%±2% by weight, composed mainly of cellulose, hemicellulose and pectin compounds, the betaine content was determined to be 715 mg/100 g±55 mg/100 g, the group B vitamins content was 18 mg/100 g±2 mg/100 g.

### Example 4

A cleaned and defoliated sugar beet after harvest with a total dry-matter content of 24.8% by weight was disintegrated by grating into shavings approximately 3 mm thick. The obtained material was immediately quantitatively divided into two parts. One part was pre-dried with hot gas, in which the oxygen content was reduced to 5% by volume, at a drying temperature of 110° C. in a fluid bed dryer under reduced light radiation intensity with a wavelength of 200 nm to 420 nm and from 550 nm to 600 nm (intensity up to 0.010 mW cm⁻² and the total energy after reaching 50% by weight of the dry matter was 20 mJ cm⁻²±5 mJ cm⁻²). Pre-drying took place until the temperature in the material reached 80° C. and the dry matter of the material increased to 50% by weight, with subsequent additional drying of the material at a temperature of 80° C. to the dry-matter content of 65% by weight. The second part was processed without the pre-drying step. Both parts were inactivated by mixing them with monohydroxy alcohols C1 to C3 as in Example 2. The concentration of the alcohol solutions used was at least 85% by volume. Each of the prepared mixtures was prepared by mixing the material after disintegration or pre-drying with one of the C1 to C3 alcohols in the specified ratios. Each mixture was then heated up in a closed vessel to a temperature of 90° C. under constant stirring for a period of 20 minutes. Each mixture was separated on the filter centrifuge to form a liquid and a solid phase. The solid phase of the pre-dried part of the material was dried at a temperature of 100° C.±10° C. until the dry-matter content reached 95% by weight. Escaping vapours were captured for the recovery of alcohols as well as for the recovery of energy by heat transfer media. Both alcohols and energy were recovered and reused in the process.

After its separation, the liquid phase of the pre-dried part of the material was winterized at a temperature of −18° C. At the same temperature, it was transferred over to the next separation, second in order, and following that separation the obtained second solid phase was dried in a fluid bed drier under the same conditions as in the previous step. During drying, the resulting evaporation was collected and used directly for the recovery of alcohols. The produced second liquid phase after the second separation was brought to the recovery of alcohols by distillation at a temperature of 45° C. and a pressure of 12.0 kPa±5.0 kPa. After the recovery of the second liquid phase, a by-product was produced which comprised of a concentrated aqueous solution of the part of the sugar beet dry matter. This by-product was then heated up to a temperature of 115° C.±10° C. in a closed space for 40 minutes, during which time it was concentrated. It was then dried to form a partial product with high antioxidant activity and a content of phenolic compounds at the level of 1.9%±0.15% by weight. In the products thus obtained after drying the first and second solid phases, the content of simple mono- and disaccharides from sugar beet, total fibre content, the complex of minerals and betaine were determined.

The quantities of the monitored substances varied in the individual partial fractions of the product in proportion to the change in the mixing ratio of the paste to alcohol in the inactivation step.

As the ratio of alcohol in the liquid phase of the mixture during inactivation increased, the sensory parameters of the obtained products improved. The winterization process provided the product only if the material was pre-dried after its disintegration to at least a 50% dry-matter content.

In the case where the material was not pre-dried, the first solid part after the first separation consisted mostly of the fibre fraction which constituted 80%±9% by weight of the dry matter in the product fraction. The other part of the product fractions thus obtained consisted of roughly 12%±8% of sugars and other non-sugar components of sugar beet. The majority of the mono- and disaccharides from sugar beet were dissolved in the liquid phase. The liquid phase after the first separation from the material without pre-drying was winterized to produce a minimum part of solid phase yield in the second separation step. In the subsequent process of recovering the alcohols from the liquid phase after the second separation, the dissolved substances were brought from the liquid phase to a distillation residue, which was further processed. The residue was divided into two halves, one half was heated up to a temperature of 110° C.±10° C. in a closed duplicator vessel for 10 minutes and then dried at a temperature of 90° C. Thus, another partial product was obtained after recovery. The other half of the distillation residue was treated by crystallisation, in the same method as for obtaining sucrose in sugar refineries, and thereby yielding raw sugar. The remainder of the resulting liquid after obtaining the raw sugar was dried to give a dry matter which formed another fraction of the product. The products were coloured in green-beige shades and had a slightly recognisable sugar beet odour. The process of washing with alcohol as in Example 1 made it possible to eliminate the green shades of the products as well as the residual negative sensory substances. By mixing them with the other product fractions produced in the first and second separation processes it was possible to produce the final product with an exact substance composition.

The solid phase obtained after the first separation from the material without pre-drying was dried at a temperature of 120° C. until the resultant dry-matter content was 90% by weight. The product obtained in this way did not contain any traces of sensory-negative substances from sugar beet and had a lighter colour than the products obtained in Example 2. The products obtained by the above-described procedure did not show degradation damage. The products obtained were of light beige colour without sensory traces of negative sensory substances from sugar beet. Partial products obtained during the recovery of alcohols from the liquid phase in the case of 1:1 to 1:1.5 mixing ratios without pre-drying of the material contained a high proportion of mono- and disaccharides of 85%±6% by weight, proteins of 3.5% to 4.1% by weight, minerals of 0.78% to 1.1% by weight, and betaine of about 620 mg/100 g±60 mg/100 g. The parts and quantities of substances always depended on the substance composition of the entering raw material.

### Example 5

Defoliated sugar beet with a sugar content of 15.6% by weight of the sucrose content was cleaned of surface impurities. Subsequently, it was disintegrated by grating, homogenised, and ground to a fine paste. In the disintegration process, 0.05% by weight of K₂S₂O₅ was added to the paste, in repeated experiments either the same amount of Na₂S₂O₅ or 0.65% by weight of NaNO₂ or 0.05% by weight of KNO₂ was added to the paste. Sodium or potassium salts were always added in the solid state (powder) in order to slow down the oxidation processes, which are enzymatically catalysed in the paste after tissue disruption. The mixed paste thus prepared was always divided into two equal parts. In the first part, the addition of citric acid (in solid form as a powder) adjusted the pH value to 3.6, in the second part of the paste, its pH was not adjusted. Both parts were individually pre-dried in a vacuum drier at a pressure of 0.1 bar±0.05 bar, at a temperature of 80° C.±10° C., to a dry matter level of 90% by weight. The materials obtained in this way had a similar substance composition to the origins from the sugar beet, but the material produced with a pH adjustment contained higher glucose and fructose monosaccharides values by 42% by weight at the expense of sucrose. Both materials were coloured in shades of beige to light green. Sensory evaluation showed that the pH-adjusted material, using the citric acid, was lighter in colour and had a lower content of sensory negative substances of sugar beet compared to the product without pH adjustment. However, the sensory properties of the materials thus obtained still showed perceptible sensory traces of negative sugar beet odour, the colour of the materials still affected the colour shade of foods and continued to degrade in the conditions with increased oxidative-reductive activity of the material in subsequent application tests. Therefore, the materials thus obtained with a moisture content of 10% to 12% by weight were further treated with monohydroxy alcohols having one to three carbons in the molecule (C1 to C3), methanol, ethanol, propanol at a concentration of 85% by weight of volume in liquid form. Alcohol solutions were used in the inactivation process as in the previous examples. After the completion of the inactivation process, the samples were separated or first cooled down to 25° C. and then individually separated in a filtration centrifuge or with the aid of a vacuum filtration, always producing a solid phase and a liquid phase. The solid portion was then dried in a vacuum drier for each sample at a temperature of 80° C.±10° C. The dry matter in the solid portion after drying comprised 90% to 95% by weight of the product, with the content of the residual alcohol in the product always below 1.0% by weight. The separated liquid portion was recovered on a distillation rectification column or on a distillation column at a pressure of 10 kPa±5 kPa. The alcohols used were thus recovered by a distillation process for their further use to form an alcohol with a concentration of at least 80% by volume and a distillation residue containing sugar beet dry matter substances which passed into the liquid phase in the separation process. The distillation residue, after recovering the alcohols, was further dried at 100° C.±5° C. and washed as in Example 1.3 to produce a product (fraction) from sugar beet with high mono- and disaccharide content, minority content of minerals and betaine.

The fibre, as an insoluble portion, always passed into the solid phase. The lowest sensory quality of the sugar beet products/concentrates was obtained with the use of methanol in comparison with other alcohols.

The substance composition of the products obtained after drying the separated solid phase and drying the processed liquid phase corresponded to the summary composition of the product in Example 2, however the product contained added allergens. Sensory properties were not impaired by negative substances derived from sugar beet.

### Example 6

Sugar beet was processed similarly as in Example 5; however, no sulphites or nitrites were added during the disintegration process, but immediately after the disintegration, the material was pre-dried and processed until the inactivation process (mixing with alcohols). The processing was performed in equipment with controlled atmosphere (gaseous nitrogen (N2) atmosphere) or with reduced pressure and reduced radiation with a wavelength of 200 nm to 400 nm and 550 nm to 650 nm at 50 mJ.cm⁻². In repeated experiments, a 1:1 (N₂:CO₂) ratio of the nitrogen and carbon oxide was used and the process was repeated on the next identical sample under a reduced pressure of 15 kPa±5 kPa. The aim was to reduce the oxygen concentration in the atmosphere in contact with the disintegrated material during the processing of the sugar beet material. The pressure of gases in the space was maintained at 100 kPa and 200 kPa. After drying the material under the procedure of Example 5, materials were produced containing a dry-matter content of 60% by weight and 92% by weight. The colour of the materials obtained after pre-drying and prior to the application of alcohols was at least comparable to the products obtained in Example 5. Subsequently, the treated material was inactivated with alcohols (C1 to C3) according to Example 5, where the colour of the products changed towards lighter shades. At the same time, residual negative odours and aromas of sugar beet were removed. The substance composition was comparable to Example 5 within the compared concentrates and measured deviations, but the content of added sulphites or nitrites in the process was 0% by weight.

### Example 7

The sugar beet paste was prepared in the same way as in Example 5, but during the disintegration, instead of potassium disulphite, a 1:1 mixture of disulphites, K₂S₂O₅ and Na₂S₂O₅, in solid form (powder), was added in an amount of 0.05% by weight for the weight of sugar beet paste.

Subsequently, a sample of the obtained paste was divided into several equal parts which were further processed. The pH values were adjusted in one half of the samples to pH=3.6±0.25 using citric acid or hydrochloric acid and in the other half of the sample's pH values were not adjusted.

All paste samples were subsequently treated separately by sonication in a closed system under constant stirring so that the resulting water vapours increased the internal pressure in the vessel. Each sample was sonicated and treated separately. The samples were sonicated at a frequency of 15 kHz, 20 kHz, and 35 kHz at a sonication energy of up to 2400 J/g of the prepared mixture, whereby the samples were evaluated after reaching a sonication energy of 65 J/g of the mixture, 250 J/g of the mixture, 600 J/g of the mixture, 1200 J/g of the mixture, and 2400 J/g of the mixture. The deviation in the measurement of sonication energy per gram of mixture was calculated to be ±12% (a total of 2×60 samples were sonicated). During the initial minutes of sonication, the sonication output fluctuated due to the high viscosity of the samples at temperatures up to 45° C. Therefore, in the next part, the samples were sonicated in the same range of parameters but in two methods, each method increasing the intensity of sonication. In the first method, the samples were additionally diluted with water in a 1:1 ratio (sugar beet paste:water). In the second method, the samples were further homogenised, heated to 70° C. with an external energy source and stirred to intensify the sonication. Thermal energy was supplied to the samples during sonication until reaching the temperature of 70° C. Samples not diluted with water showed a lower intensity of actually transferred sound energy at the same sonication time compared to diluted samples, by an average of 38%±12% in the total sound energy. Samples heated up by an external heat source showed a higher intensity of actually transferred sound energy at the same sonication time compared to the samples that were not heated or diluted, by an average of 26%±12% in the total sound energy. The temperature increase of the mixtures during sonication was proportional to the sonication power and sound energy. The sonication was carried out in each of the samples in a closed vessel, and the process was repeated with other identical samples of sugar beet paste. During intensive and long sonication, the samples became overheated during the sonication process. Therefore, during longer and more intensive sonication it was necessary to cool the samples in the final stages of the process in order that the temperature of the material did not exceed 90° C., because after this temperature has been exceeded the sonication power dropped significantly. After the sonication of the material, the sonicated material was pre-dried and subsequently inactivated with alcohols as in Example 1. After the inactivation, the material was separated and dried as in Example 1. The sonicated material thus obtained was dried under reduced pressure to reduce energy and time requirements for the drying process, at a temperature of 100° C.±20° C. and after evaporation of more than 50% of liquids from the mixture the drying temperature was maintained at 60° C. The same result of drying according to the mentioned parameters in terms of the quality of the product obtained was also achieved during classical drying at atmospheric pressure, where drying at the same temperatures took longer and was more energy intensive. Various drying methods were tested and measured on the samples, namely infrared drying, microwave drying, conduction and thermal drying as a means to optimise the energy demands for the process. Drying was always terminated when the dry-matter content reached 60%±5% by weight (gel-like consistency) and 90%±5% by weight (dry powder material). After the materials had dried to a dry-matter content of 80% or more, some samples were ground to the desired particle size, while part of the water was additionally evaporated due to the influence of friction during the grinding process. In this way, depending on the sonication time, sonication intensity measured in J/g, sonication frequency in kHz and particle granulation achieved during grinding in μm, different types of materials were obtained. These differed from one another by rheological properties when mixed with water. Based on these results, dependencies were defined. The viscosity of the sonicated material decreased as the sonication power and heat in individual samples increased and analogously with the sonication power and heat, the viscosity of the products dried to the 60% content of the dry matter as well as the viscosity of the solutions obtained by mixing the resulting dried powder sugar beet products/concentrates with water (while maintaining the same mixing ratio of the sample and water) decreased. This result was a presumed consequence of decreasing the average molecular weight of the dry matter of the material during sonication. Simultaneously, with the intensity of sonication the portion of soluble dry matter of the concentrates that dissolved and passed into solution or into an indivisible microsuspension with water increased after dissolving the dried sugar beet product/concentrate in water. As the sound energy increased in the sonication process of the material, the portion of insoluble fibre in the material was reduced and more stable suspensions were formed, which is important in terms of the application in certain types of foods.

The sonication frequency influenced the rheological changes achieved as well as the sensory quality of the concentrates. The worst results regarding the adjustment of sensory and rheological parameters of the samples were obtained at a sonication frequency of 35 kHz, the best results were obtained at a sonication frequency of 20 kHz. The first change in the rheological properties of the sonicated mixtures at 20 kHz occurred when the sound energy reached a value of 140 J/g to 220 J/g. With increasing sound energy per gram of the material, the viscosity decreased and at the same time, after drying, the product obtained became more soluble in water. The solubility was evaluated by measuring the portion of dissolved dry matter in water solution, where, after filtration of the suspension formed by mixing the obtained sugar beet concentrates with water, the mass portion of insoluble dry matter on the filtration interface was evaluated. Changes in sonicated sugar beet concentrates were also observed during drying and subsequent grinding, when with the increase in sound energy in J/g the preparations dried faster at the same energy pulse and at the same mechanical pulse, during the subsequent grinding process, the average particle size as well as the grinding energy of concentrates decreased in proportion to the intensity of sonication (J/g). The results were measured on a system of sieves with a mesh size of 80 μm, 160 μm, 250 μm, 500 μm, where the described rheological changes in the grinding process were demonstrated in an increase in the weight of fractions with smaller particle size at the same grinding energy.

Changes in sensory properties during sonication of materials occurred gradually. The colour change occurred gradually when the sound energy reached a level of 700 J/g to 1280 J/g, when the sonicated content gradually began to darken in individual samples. The colour change was also apparent in the obtained sugar beet concentrates after drying. The colour changes were not demonstrably pH-dependent during sonication. The organoleptic properties (especially flavour and aroma) improved with an increase in sound energy in the sonicated samples and the intensity of sugar beet odours decreased. The lowest intensity of negative taste and aromatic sensations from sugar beet was achieved with the most intensive sonication at a frequency of 20 kHz and a sonication output of 2400 J/g, evaluated before inactivation. The increase in temperature during the sonication process was proportional to the increase in sonication performance with sonication of all mixtures over time. The colour of the concentrates obtained intensified with the time of sonication towards darker shades of the original light brown and light green, but subsequent inactivation and separation eliminated these colour changes.

Structural changes in the sugar beet material during sonication led to changes in the rheological properties of the sugar beet concentrates obtained, manifested in particular by a change in viscosity and solubility in the mixtures with water, as well as the formation of more stable suspensions and emulsions in the mixture with water and/or fats. Subsequently, during the drying of the sonicated products/concentrates, a shortening of the drying process (easier release of water at the same energy pulse) and a finer resultant product was observed during the grinding process of sugar beet concentrates.

Content of simple sugars in dry matter of 96% by weight of the sugar beet concentrate was determined to be 66% by weight to 72% by weight in the case of the mentioned method. The total fibre content was determined to be from 16.5% to 24.2% by weight in the dry matter, the content of minerals changed only minimally and was determined at 1.06%±0.18% and the betaine content was determined to be 486 mg/100 g±96 mg in the dry matter of the concentrate. The resultant substance composition of sugar beet concentrates depended on the duration, power, and temperature of the sonication. The representation of individual substances in the sugar beet used in the processing procedure is an important factor influencing the substance composition of the obtained concentrates and preparations from sugar beet.

### Example 8

The procedure as in the previous example was repeated, but the sugar beet was disintegrated only after inactivation, which took place only using ethanol with a concentration of 95% by volume. The inactivation process took place in a closed pressure vessel at a temperature of 100° C. Subsequently, after drying and grinding the obtained concentrates for granulation to a maximum particle size of 250 μm under the procedure in Example 2, the ethanol-based washing process was applied.

The washing was repeated by re-mixing the sugar beet product/concentrate with ethanol at a concentration of 95% by volume in a ratio of 1:1, the mixture was heated up at 90° C. under constant stirring for 10 minutes. Subsequently, the mixture was cooled down to −10° C., and the solid portion and liquid portion were separated on a filter centrifuge. The solid part after separation was dried at 120° C. and 100° C., in which the escaping vapours were captured and used to recover ethanol for reuse. The separated liquid portion was recovered by distillation to produce concentrated ethanol of 95% by volume and a distillation residue which contained mainly saccharides in the dry matter.

The separated solid part after drying to a dry-matter content of 92%±5% by weight represented a sugar beet product/concentrate with a noticeably lighter colour, with better organoleptic parameters of the product than those of the concentrates obtained using ethanol in Example 2. The substance composition of the concentrate thus obtained, when compared to the sugar beet concentrates obtained in Example 2 with ethanol, was similar in the framework of the deviations. As a result of the repeated washing process using ethanol, a sugar beet concentrate was obtained with improved sensory properties, applicable in the preparation of a broader range of food products.

### Example 9

As in Example 2, sugar beet samples were processed with pre-drying to 60% by weight of the dry matter up to the inactivation step. The inactivation step was performed with ethanol at a concentration of 95% by volume, but immediately after inactivation in all samples the liquid portion was separated from the solid portion by filtration. More efficient separation was performed by centrifugal separation to form a separated solid and liquid portion.

The phases were separated at −5° C. and 60° C. by centrifuge. With decreasing temperature during the separation, the portion of sugar beet dry matter dissolved in the liquid phase decreased. The liquid portion formed after separation at a temperature of 60° C. was divided into two halves. One half was transferred for winterization, where it was cooled down to −18° C. The other half was recovered by distillation to form concentrated alcohol for further use and a distillation residue. The winterization yielded from the liquid phase a secreted solid portion forming in the liquid as a result of the reduced solubility of substances at a lower temperature of the mixture in the liquid phase. This solid part after winterization consisted mainly of simple sugars and saccharides originating from sugar beet, which were subsequently separated by filtration at a temperature close to winterization. The separated liquid (filtrate) after winterization was pumped to recover alcohols in order to concentrate the alcohol solution for further use.

As a result, it was confirmed that the amount of soluble portion of the sugar beet dry matter in the liquid phase after winterization in the separation depends on the used ratio of sugar beet paste:alcohol in the inactivation step (as described below). The solid portion formed after winterization was directly dried in the same way as in the preceding examples, until reaching the dry matter portion of at least 95% by weight. The resultant particle size of the concentrate thus obtained after drying was additionally adjusted by grinding.

The solid part (phase) contained after the first separation up to 25% of the residual liquid which was removed by drying at temperatures up to 140° C. with the use of combined drying, always in combination of two methods (specifically), namely the application of microwave drying, vacuum drying, fluid bed drying or extrusion processing (the use of adiabatic expansion). Combined drying, microwave or vacuum drying was used in the first drying step until the moisture content of the material fell below 50% by weight, followed by drying the material in a fluid bed dryer or extrusion. Microwave irradiation or fluid bed drying with reduced oxygen content (heated nitrogen gas) was used for pre-drying.

Drying of the solid phase was always carried out in such a way that the resulting evaporation produced during drying was captured and brought for separation on the rectification column at atmospheric pressure, but the process of the recovery of alcohols under vacuum was more advantageous in terms of energy and time. The concentration of recovered alcohol after concentration was above 80% v/v in the mixture after recovery.

The resultant composition of the products obtained from the solid part after the separation of phases is proportionally dependent on the selected ratio of sugar beet paste and ethanol in the inactivation step and the temperature before and during the separation of phases.

Overall, the substances in the liquid and solid phases after separation always equalled the quantity of substances entering the process in the sugar beet paste (taking into account technological losses in the process). The sensory properties of the concentrates thus obtained were satisfactory in each case, comparable in colour and organoleptic terms to the sugar beet concentrates obtained in Example 2. The content of negative sugar beet substances was minimal to none.

### Example 10

The sugar beet was processed in the same way as in Example 2, with the mixture being pre-dried to 60% by weight. In the inactivation step, alcohol with a concentration of 95% by volume in a 1:2 ratio (material:alcohol) was used, the mixture was heated up to 85° C.±5° C. for 10 minutes. In the inactivation step, the mixture of sugar beet paste with alcohols was at the same time sonicated at a frequency of 18 kHz and 22 kHz, with the temperature of the mixture maintained at a maximum of 80° C. or less. Subsequently, the mixture was divided into two halves after sonication. One half was tempered in a closed duplicator vessel at a temperature of 120° C.±5° C. for 5 minutes, then dried to produce a powdery product containing the dry matter of 90% by weight. The other part was cooled down to 10° C. and brought to the separation of phases during which the portion of solid phase was separated from the portion of liquid phase, wherein the solid portion was dried in a vacuum drier and the liquid portion was submitted to winterization at a temperature of −18° C. The portions of solid phase formed after separation and portions of the solid phase after winterization and after subsequent drying were mixed. By the grinding process, their granulation was adjusted to a particle size of below 500 μm. The difference in the sonication process compared to the sonication in Example 7 was mainly that the sonicated material did not change colour even when the supplied sonication energy exceeded 1200 J/g. Sonication power began to decline significantly after reaching 70° C. At this temperature, it was necessary to begin cooling the sonicated sample when it reached a maximum of 70° C. in the mixture in order to maintain the power and efficient direction of sonication energy into the sample. The changes in material in relation to the temperature and sonication performance were analogous to Example 7, however, the sonication power decreased already at lower temperatures. For use in food production, the process of intensive sonication at sonication energy values above 400 J/g was particularly advantageous for technologies where lower viscosity and lower water binding properties of materials in water solutions are required (e.g., in the manufacture of biscuits, chocolate). Conversely, a low sonication energy below 100 J/g or a sonication free process is suitable for the manufacture of food materials and products that in the process of their production require high water binding property and stability of the resulting gels to produce more viscous water solutions (e.g., bakery production or manufacture of jams and fillings).

### Example 11

The sugar beet was disintegrated, and the sugar beet pastes were processed in the same procedure as in Example 10. The difference was that the disintegration, inactivation, sonication, and tempering processes were performed in an environment with controlled atmosphere and without access of light radiation in the wavelength range from 100 nm to 420 nm, similar to Example 6. The products obtained had the same substance composition and sensory quality as the products obtained in Example 7, but were even lighter in colour.

### Example 12

Sugar beet was disintegrated into particles where at least one particle size was 3 mm, at a temperature of 25° C. in an environment with reduced solar radiation intensity where the total radiation energy in contact with the material was reduced to 50 mJ.cm⁻² and where the radiation intensity did not exceed 0.040 mW.cm⁻² at wavelengths from 200 nm to 420 nm, and 550 nm to 650 nm. The atmosphere of the environment contained atmospheric air with an oxygen content of 21.8%. Subsequently, the material was divided into two halves. One part was left exposed for 30 minutes freely stored in the conditions without the reduction of solar radiation and the other part was kept in the conditions with reduced radiation. After 30 minutes we found that the material exposed to solar radiation showed signs of degradation, a slight change in colour of the surface from white to light pink to red could be detected with the naked eye, whereas the material kept in the space with reduced light radiation energy at the same moment showed no signs of incipient degradation or colour changes. Both materials were subsequently inactivated with ethanol as in the previous example, though the material exposed to solar radiation in the inactivation process changed its colour to grey to dark, while the material maintained in the reduced radiation space showed no signs of degradation or colour changes. These features were detectable in terms of sensory and colour properties even in the prepared products after inactivation and drying, while the difference in the quality of materials became even more pronounced during the drying process.

### Example 13

The sugar beet product/concentrates were obtained in the same method as in Example 10, the ground product to a particle size below 500 μm was subsequently fractionated using dry fluid fractionation in an air flow with a variable flow in a fluid tunnel. In this method, the powdered product was divided on the basis of the density and fly-up threshold of the material particles. As a result, two fractions of the material were produced that differed in their content of sugars, fibre, minerals, betaine as well as vitamins. Both of the fractions showed no negative sensory traces of sugar beet. Both fractions were of a light, yellow-creamy colour, with the first fraction in which the mono- and disaccharides were concentrated being of a significantly paler, whiter colour. The first fraction contained 80%±6% by weight of mono- and disaccharides, 0.92%±0.24% by weight of mineral substances, and 11.2%±3.5% by weight of total fibre. The second fraction was of a light yellow-creamy colour, and contained 42%±8% by weight of fibre fraction (especially pectin substances, hemicellulose, and cellulose), 1.82%±0.14% of minerals and 920 mg/100 g±112 mg/100 g of betaine.

### Example 14

All the products gained in the preceding examples showed, after drying, a dry-matter content of 90% by weight or more, hygroscopic properties, i.e. they were absorbing by binding atmospheric humidity under normal atmospheric conditions, thereby increased the inherent moisture content. For this reason, the products were mixed with palm oil, rapeseed oil or cocoa butter at a temperature of 45° C. in 25:1 to 1:4 ratios (sugar beet concentrate:fat). This resulted in mixtures whose hygroscopicity was significantly lower compared to any sugar beet concentrate produced according to the examples above.

### INDUSTRIAL APPLICABILITY

The presented solution makes it possible to obtain a sugar beet concentrate/product which consists of a whole sugar beet root or of its individual fractions according to the technical solution of the present teaching, and is suitable as a food ingredient with functional properties in food production technology or as an alternative to sugar with better nutritional parameters (content of minerals, betaine, fibre, polyphenols, etc.) than in classically produced beet sugar, while the sensory parameters of the obtained product are not impaired by unpleasant aroma or odour of sugar beet, or degradation or oxidation products taking place immediately after the disruption of sugar beet tissues. The sensory and nutritional quality of the products obtained is sufficient for their wide application in the food industry. The technological properties of the materials thus obtained—sugar beet concentrates, and preparations are suitable for application in various branches of the food industry (bakery production, jam production, chocolate production, production of confectionery, biscuits, dairy products, functional foods, and others) as ingredients and sweeteners with nutritional benefits, which at the same time allow the food production process to be more advantageous. Last but not least, due to the content of pectin components and soluble fibre, there is also a positive reduction in caloric load and glycemic index compared to refined beet sugar (crystalline sucrose).

1. A method of processing sugar beet and its varieties into a product usable in the food-processing industry that includes the following:
a) inactivation of a sugar beet against degradation and elimination of undesirable sensory substances, which includes:
i. mixing of the sugar beet with one or several alcohols selected from a group of alcohols containing one to four carbon atoms in the molecule and one hydroxyl group in such a ratio that the minimum concentration of alcohol in a resulting liquid phase of the mixture is at least 60% by volume, at a temperature of −15° C. to 180° C.;
ii. maintaining the mixture of material and alcohol until reaching the technically same concentration of alcohols in the entire volume of the mixture;
b) disintegration of sugar beet roots before, during or after the inactivation, into a material of particles, where at least one of the particle dimensions is less than or equal to 50 mm, where the disintegration of the roots occurs prior to the inactivation, then:
the time between disintegration and inactivation is at most 24 hours and shortens proportionally as the surface of the disintegrated material increases, so that disintegration into a paste is directly followed by inactivation; and/or
during or immediately after disintegration and prior to inactivation, the disintegrated material is shock-heated to a temperature of at least 80° C.; and/or
during or immediately after disintegration, the disintegrated mass is pre-dried with a flow of gas (gases) at a temperature of 25° C. to 180° C., until reaching a moisture content of the material of at most 50% by weight, but where the gases contain at least 12% of oxygen, then the gas flow rate in the drying space must be 5.0 m.s⁻¹ to 40 m.s⁻¹; and/or
all actions from disintegration to inactivation (inclusive) take place:
in a controlled atmosphere where the oxygen content is reduced by at least 40% against the oxygen content in the Earth's atmosphere, and
in an environment where the amount of energy emitted at a wavelength from 100 nm to 1100 nm, is at most below 300 mJ cm⁻², and
c) removing the liquid phase from the mixture to form a product with a dry-matter content of 40% by weight up to 100% by weight.

2. The method according to claim 1, where the alcohol in the inactivation is ethanol and/or methanol and/or propanol.

3. The method according to claim 1, where (c) includes:
heating of the mixture in a closed space to a temperature of 85° C. to 135° C. and, once this temperature has been reached, the generated vapours begin to be removed from the space until the alcohol content in the material falls below 5% by weight, or the liquid content falls below 60% by weight in the mixture, subsequently the material is dried until reaching a dry-matter content of 40% by weight up to 99.9% by weight; or
separation of the mixture into a solid and a liquid phase which are further treated separately so that:
the solid phase is dried to form a product with a dry-matter content of 40% by weight up to 100% by weight,
from the liquid phase, the alcohol is recovered and the residue after removal of the alcohol is dried to form a product with a dry-matter content of 40% by weight up to 100% by weight, or it is crystallised, and
where, before and during the separation process of the mixture, the mixture is preferably maintained at a temperature between −15° C. to 30° C.

4. The method according to claim 1, where in (c) and/or during the pre-drying the mixture/material is dried at a temperature exceeding 100° C. at a moisture content of the mixture/material above 50% by weight and at a temperature below 100° C. at a moisture content of the mixture/material below 50% by weight.

5. The method according to claim 1, where the vapours from (a) or (c) are captured for alcohol recovery and where the distillation residue from the alcohol recovery is dried.

6. The method according to claim 1, where (c) is carried out at temperatures from 30° C. to 160° C. at atmospheric pressure, or under reduced pressure, or at a reduced oxygen concentration in the space.

7. The method according to claim 3, where the liquid phase is winterized before recovery at temperatures in the range of −30° C. to 10° C., and subsequently the portion of the dry matter obtained by winterization is separated a second time and the solid phase obtained by the second separation is dried to form a product with a dry-matter content of at least 40% by weight.

8. The method according to claim 1, where the material or mixture is sonicated at frequencies from 15.0 kHz to 40 kHz for 1 minute to 6 hours at a sonication power of 30 J/g to 4500 J/g.

9. The method according to claim 8, where during the sonication the temperature of the mixture is maintained by an external action of energy at a temperature of 60° C. to 85° C.

10. The method according to claim 1, where the gas in the pre-drying is air with an oxygen content of at most 12%, nitrogen, a mixture of nitrogen and carbon dioxide, and/or carbon dioxide.

11. The method according to claim 1, where Na₂S₂O₅ and/or K₂S₂O₅ is added directly to the sugar beet during the disintegration or before inactivation in an amount up to 0.05% by weight and/or NaNO₂ and/or KNO₂ in an amount up to 0.95% by weight, in solid crystalline form, depending on the weight of the sugar beet.

12. The method according to claim 1, where an organic or inorganic acid is added to the material prior to inactivation in such an amount that the resulting pH of the mixture is 2.0 to 4.9.

13. The method according to claim 1, where (a) to (c) are performed in an environment where the energy of electromagnetic radiation in contact with the material of a wavelength of 200 nm to 420 nm and 550 nm to 650 nm is at most 300 mJ.cm⁻².

14. The method according to claim 1, where the obtained product is further mixed with one or more alcohols selected from the group of alcohols containing one to four carbon atoms in the molecule and one hydroxyl group, where the concentration of alcohols prior to mixing is at least 70% by volume in the product-to-alcohol ratio of 4:1 to 1:5, and is subsequently washed for 0 minutes up to 600 minutes at temperatures of 0° C. to 90° C.; the solid phase is separated and subsequently dried, while from the liquid phase alcohol is recovered.

15. The method according to claim 1, where the product or material obtained before the inactivation with a dry-matter content of 80% by weight or more is subsequently ground and fractionated and/or mixed with vegetable fats and/or oils, the fat-to-product ratio is 1:2 to 1:50.

16. A sugar beet product obtained by the method according to claim 1, wherein it contains at least 80% by weight of mono- and disaccharides in the mixture and at least 0.15% by weight of minerals, where the minerals are predominantly represented by a mixture of potassium, iron, calcium, magnesium, and their compounds, and betaine in a total amount of at least 100 mg/kg.

17. A product obtained by the method according to claim 1, wherein it contains at least 40% by weight of total fibre consisting mainly of substances from the group of pectin, cellulose and hemicellulose, their subunits and compounds in the mixture and which contains at least 5% by weight of monosaccharides, disaccharides and oligosaccharides in the mixture, and at least 0.5% by weight of minerals, with the majority weight representation of minerals including the chemical elements potassium, iron, calcium, magnesium and their compounds.

18. A product obtained by the method according to claim 1, the colour of which is in shades of white, or shades of yellow or shades of beige, and contains: pectic substances, hemicellulose, cellulose, mono- and disaccharides with a calorific value and minerals and betaine, in the total amount of these substances in the mixture of at least 80% by weight in dry matter, where the moisture content is at most 60% by weight and the content of added sulphites and nitrites in the process is 0% by weight.

19. A product obtained by the method according to claim 1, containing in the dry matter at least 1.0% of compounds which contain phenol in the molecule or show antioxidant activity.

20. A food containing a product according to claim 16.
